(19) United States
(12) Patent Application Publication
(10) Pub. No.: US 2014/0227506 A1
(43) Pub. Date: Aug. 14, 2014

(54) FOAMED AROMATIC POLYESTER-BASED RESIN PARTICLES FOR IN-MOLD FOAM MOLDING AND METHOD OF PRODUCING THE SAME, IN-MOLD FOAM MOLDED PRODUCT, COMPOSITE STRUCTURAL COMPONENT, AND COMPONENT FOR AUTOMOBILE

(71) Applicants: Yusuke Kuwabara, Tenri-shi (JP); Yosuke Kawamorita, Tenri-shi (JP); Akira Isayama, Tenri-shi (JP); Hiroki Owaki, Tenri-shi (JP); Yuta Fukuzaki, Tenri-shi (JP)

(72) Inventors: Yusuke Kuwabara, Tenri-shi (JP); Yosuke Kawamorita, Tenri-shi (JP); Akira Isayama, Tenri-shi (JP); Hiroki Owaki, Tenri-shi (JP); Yuta Fukuzaki, Tenri-shi (JP)

(21) Appl. No.: 14/239,540

(22) PCT Filed: Aug. 28, 2012
(86) PCT No.: PCT/JP2012/071702

§ 371 Date: Feb. 18, 2014

(30) Foreign Application Priority Data
Aug. 29, 2011 (JP) 2011-186311
Aug. 29, 2011 (JP) 2011-186314

(51) Int. Cl. C08J 9/12; B32B 5/18; B32B 27/36; C08G 63/183

(52) U.S. Cl. CPC C08J 9/122; C08G 63/183; B32B 5/18; B32B 27/36; C08J 2367/02
USPC 428/304.4; 521/182; 264/5

(57) ABSTRACT

Provided are foamed aromatic polyester-based resin particles for in-mold foam molding that have a long shelf life after production and can be used to produce an in-mold foam molded product having high mechanical strength and good appearance. The foamed aromatic polyester-based resin particles for in-mold foam molding contain an aromatic polyester-based resin and are characterized in that the content of residual carbon dioxide 7 hours after the particles are impregnated with carbon dioxide for 24 hours under the conditions of 25° C. and 1 MPa is 5% by weight or more.

### FIELD

The present invention relates to foamed aromatic polyester-based resin particles for in-mold foam molding and a method of producing the same, an in-mold foam molded product, a composite structural component, and a component for automobiles. In the following description, the “foamed aromatic polyester-based resin particles for in-mold foam molding” may be referred to simply as “foamed aromatic polyester-based resin particles.”

### BACKGROUND

A general method conventionally used to produce an aromatic polyester-based resin foam-molded product by foaming foamed aromatic polyester-based resin particles is in-mold foam molding. The in-mold foam molding is a molding method including: the step of filling a mold with the foamed aromatic polyester-based resin particles; and the step of heating the foamed aromatic polyester-based resin particles in the mold using a heating medium such as hot water or water vapor to foam the foamed aromatic polyester-based resin particles, so that the foamed aromatic polyester-based resin particles are secondary-foamed through their foaming pressure, and the obtained secondary foamed particles are heat-fused and integrated with each other, whereby an in-mold foam molded product having a desired shape is produced.

One method proposed to produce the foamed aromatic polyester-based resin particles is a method in which a strand-shaped foam obtained by extrusion foaming is cooled and then cut to produce the foamed aromatic polyester-based resin particles.

More specifically, Patent Literature 1 discloses primary foamed particles obtained by cutting a strand-shaped foam obtained by extrusion foaming of an aromatic polyester-based resin using a nozzle die. These primary foamed particles have a bulk density of 0.08 to 0.15 g/cm³ and a maximum particle diameter of 1.0 to 2.4 mm. In these primary foamed particles, a value obtained by dividing a cell diameter in an extrusion direction by a cell diameter in a direction perpendicular to the extrusion direction is 3.0 to 6.0, and a value obtained by dividing a particle length by a maximum particle diameter is 1.2 to 1.6. Patent Literature 1 also discloses pre-foamed aromatic polyester-based resin particles for in-mold foam molding that are obtained by impregnating the above primary foamed particles with a pressurized gas and then re-foaming the resultant primary foamed particles. These pre-foamed aromatic polyester-based resin particles have a bulk density of 0.02 to 0.06 g/cm³.

Since a relatively low-density in-mold foam molded product obtained by molding of such pre-foamed particles is light weight and has high strength, the in-mold foam molded product is preferably used for containers for food transportation.

Such an in-mold foam molded product is also used for applications such as packaging materials used for transporting heavy products and automobile components used as structural materials. In such applications, since high strength is required, an in-mold foam molded product having a relatively high bulk density is used, and the primary foamed particles are used for in-mold foam molding without any treatment.

The above-described primary foamed particles are produced by cutting the strand-shaped foam using, for example, a pelletizer and formed into a shape close to a cylindrical shape, as also shown in a Comparative Example. Therefore, the primary foamed particles have a problem in that their mold fillability is low. In the pre-foamed particles obtained by re-foaming (pre-foaming) these primary foamed particles, the above problem is improved. However, these particles still have a shape close to a cylindrical shape and have a problem in that the mold fillability is still low.

Since the primary foamed particles are produced by cutting the cooled strand-shaped foam, cross sections of cells appear on the cut surfaces of the obtained primary foamed particles and pre-foamed particles. Therefore, in a foam molded product obtained by in-mold foam molding using the primary foamed particles or the pre-foamed particles, cross sections of cells are partially scattered on the surface of the foam molded product, and the foam molded product has a problem in that its appearance is poor because of the mottled surface texture.

Since the primary foamed particles are produced by cutting the cooled strand-shaped foam, cross sections of cells appear on the cut surfaces of the obtained primary foamed particles, and their foaming gas retention ability is low because of their high open cell ratio. Therefore, when in-mold foam molding is performed using these primary foamed particles, the foaming pressure of the primary foamed particles is insufficient, and the obtained foamed particles are not sufficiently heat-fused and integrated with each other, so that the obtained foam molded product has a problem in that its mechanical properties are low. When the foaming pressure of the primary foamed particles is insufficient, internal pressure may be provided to the foamed particles by impregnating the foamed particles with a gas such as carbon dioxide before in-mold foam molding. However, since the gas retention ability of the foamed particles is low, this method has a problem in that the shelf life (moldable life) of the resultant foamed particles after production or after the internal pressure is provided is short.

### CITATION LIST

### Patent Literature

Patent Literature 1: Japanese Patent Application Laid-Open No 2001-347535

### SUMMARY

### Technical Problem

The present invention provides foamed aromatic polyester-based resin particles for in-mold foam molding and a method of producing the same. The foamed aromatic polyester-based resin particles have a long shelf life after production and can be used to produce an in-mold foam molded product having high mechanical strength and good appearance. The present invention also provides an in-mold foam molded product, a composite structural component, and a component for automobiles that are obtained using the foamed aromatic polyester-based resin particles for in-mold foam molding.

### Solution to Problem

The foamed aromatic polyester-based resin particles for in-mold foam molding according to the present invention contain an aromatic polyester-based resin and are characterized in that the content of residual carbon dioxide 7 hours after the particles are impregnated with carbon dioxide for 24 hours under the conditions of 25° C. and 1 MPa (this content may be referred to simply as “residual carbon dioxide content (after 7 hours)”) is 5% by weight or more.

The foamed aromatic polyester-based resin particles contain the aromatic polyester-based resin as a main ingredient because high heat-fusion bondability is achieved. The “main ingredient” means that the resin constituting the foamed aromatic polyester-based resin particles contains 90 to 100% by weight of the aromatic polyester-based resin.

The aromatic polyester-based resin is a polyester containing an aromatic dicarboxylic acid component and a diol component, and examples thereof may include polyethylene terephthalate, polypropylene terephthalate, polybutylene terephthalate, polycyclohexane dimethylene terephthalate, polyethylene naphthalate, and polybutylene naphthalate. Of these, polyethylene terephthalate is preferred. Only one type of aromatic polyester-based resin may be used, or a combination of two or more types thereof may be used.

The aromatic polyester-based resin may contain, as a constituent, for example: a trivalent or higher polyvalent carboxylic acid such as a tricarboxylic acid, for example, trimellitic acid, or a tetracarboxylic acid, for example, pyromellitic acid or an anhydride thereof; or a trihydric or higher polyhydric alcohol such as a triol, for example, glycerin or a tetraol, for example, pentaerythritol, in addition to the aromatic dicarboxylic acid component and the diol component.

The aromatic polyester-based resin used may be a recycled material recovered and regenerated from used PET bottles.

The intrinsic viscosity (IV value) of the aromatic polyester-based resin used as a raw material of the foamed aromatic polyester-based resin particles of the present invention is preferably 0.8 or higher and more preferably 0.83 or higher because high extrusion foamability can be achieved and the foaming gas retention ability of the obtained foamed aromatic polyester-based resin particles is high.

If the intrinsic viscosity (IV value) of the aromatic polyester-based resin used as a raw material of the foamed aromatic polyester-based resin particles of the present invention is too high, the extrusion foamability of the aromatic polyester-based resin deteriorates, and the expansion ratio of the foamed aromatic polyester-based resin particles becomes low, so that a low-density in-mold foam molded product may not be obtained or the mechanical properties of the in-mold foam molded product may deteriorate. Therefore, the intrinsic viscosity (IV value) of the aromatic polyester-based resin used as a raw material of the foamed aromatic polyester-based resin particles of the present invention is preferably 1.1 or lower, more preferably 1.05 or lower, and particularly preferably 1.0 or lower.

The intrinsic viscosity (IV value) of the aromatic polyester-based resin is a value measured according to JIS K7367-5 (2000). More specifically, the aromatic polyester-based resin is dried at 40° C. and a degree of vacuum of 133 Pa for 15 hours.

0.1000 g of the aromatic polyester-based resin is collected as a sample and placed in a 20 mL volumetric flask, and about 15 mL of a solvent mixture (50% by weight of phenol and 50% by weight of 1,1,2,2-tetrachloroethane) is added to the volumetric flask. The sample in the volumetric flask is placed on a hot plate and heated to about 130° C. to melt the sample. After the sample is melted, it is cooled to room temperature, and its volume is adjusted to 20 mL to thereby produce a sample solution (sample concentration: 0.500 g/100 mL).

8 mL of the sample solution is supplied to a viscometer using a whole pipette, and the temperature of the sample is stabilized using a water bath containing water at 25° C. Then the flow-down time of the sample is measured. To change the concentration of the sample solution, the solvent mixture is added to the viscometer in an amount of 8 mL each time and mixed with the sample solution to dilute it, and a diluted sample solution is thereby produced. Then the flow-down time of the diluted sample solution is measured. Separately from the sample solution, the flow-down time of the solvent mixture is measured.

The intrinsic viscosity of the aromatic polyester-based resin is computed using the following computation formulas. The following values are computed using the flow-down time (t₀) of the solvent mixture and the flow-down time (t) of the sample solution.

Relative viscosity (ηᵣ)=t/t₀

Specific viscosity (ηₛₚ)=(t−t₀)/t₀=ηᵣ−1

Reduced viscosity=ηₛₚ/C

A graph with the reduced viscosity on the vertical axis and the concentration C of the sample solution on the horizontal axis is produced using the results of measurement on different diluted sample solutions obtained by changing the concentration C (g/100 mL) of the sample solution, and the intrinsic viscosity [η] is determined from the vertical intercept obtained by extrapolation of the obtained linear relation at C=0.

$$Intrinsic viscosity [ η ] = {lim}_{C \to 0} ( {η}_{SP} / C ) \qquad [ Formula 1 ]$$

The aromatic polyester-based resin constituting the foamed aromatic polyester-based resin particles may be a reformed aromatic polyester-based resin cross-linked with a cross-linking agent. A known cross-linking agent is used, and examples thereof may include dianhydrides such as pyromellitic dianhydride, polyfunctional epoxy compounds, oxazoline compounds, and oxazine compounds. Only one type of cross-linking agent may be used, or a combination of two or more types may be used.

When the aromatic polyester-based resin is reformed by cross-linking with the cross-linking agent, the aromatic polyester-based resin and the cross-linking agent may be supplied to an extruder when the foamed aromatic polyester-based resin particles are produced to thereby cross-link the aromatic polyester-based resin with the cross-linking agent in the extruder. If the amount of the cross-linking agent supplied to the extruder is small, the melt viscosity of the molten aromatic polyester-based resin becomes too low, so that the cells of the foamed particles may be broken. If the amount of the cross-linking agent supplied to the extruder is large, the melt viscosity of the molten aromatic polyester-based resin becomes too high, so that it may be difficult to perform extrusion foaming. Therefore, the amount of the cross-linking agent supplied to the extruder is preferably 0.01 to 5 parts by weight based on 100 parts by weight of the aromatic polyester-based resin and more preferably 0.1 to 1 parts by weight.

If the Z average molecular weight of the aromatic polyester-based resin constituting the foamed aromatic polyester-based resin particles of the present invention is too low, the foaming gas retention ability of the foamed aromatic polyester-based resin particles may deteriorate, or the mechanical strength of an in-mold foam molded product to be obtained may be reduced. Therefore, the Z average molecular weight is preferably 2.0×10⁵ or higher and more preferably 2.3×10⁵ or higher.

If the Z average molecular weight of the aromatic polyester-based resin constituting the foamed aromatic polyester-based resin particles of the present invention is too high, the foamability of the foamed aromatic polyester-based resin particles deteriorates. In this case, the secondary foamability of the foamed aromatic polyester-based resin particles during in-mold foam molding becomes low, and the heat-fusion bondability of secondary foamed particles obtained by secondary foaming of the foamed aromatic polyester-based resin particles becomes low, so that the mechanical strength of a foam molded product to be obtained may deteriorate. Therefore, the Z average molecular weight of the aromatic polyester-based resin is preferably 5.0×10⁵ or lower, more preferably 4.0×10⁵ or lower, and particularly preferably 3.5×10⁵ or lower.

When the aromatic polyester-based resin constituting the foamed aromatic polyester-based resin particles is a reformed aromatic polyester-based resin, the Z average molecular weight of the aromatic polyester-based resin constituting the foamed aromatic polyester-based resin particles means the Z average molecular weight of the reformed aromatic polyester-based resin.

In the present invention, the Z average molecular weight (Mz) of the aromatic polyester-based resin constituting the foamed aromatic polyester-based resin particles is a value measured as a styrene-equivalent molecular weight by an internal standard method using gel permeation chromatography (GPC).

More specifically, for example, 0.5 mL of hexafluoroisopropanol (HFIP) and 0.5 mL of chloroform containing 0.1% by weight of butylhydroxytoluene (BHT) are added in that order to about 5 mg of a sample of the foamed aromatic polyester-based resin particles, and the mixture is shaken and left to stand for about 5 hours. After it is confirmed that the sample is completely dissolved in the solution, chloroform containing 0.1% by weight of butylhydroxytoluene (BHT) is added to the solution to dilute the solution such that the volume of the resultant solution is 10 mL. The resultant solution is shaken and mixed. Then the solution is filtrated through a 0.45 μm nonaqueous chromatodisc. The measurement is performed using the filtrated solution. The Z average molecular weight (Mz) of the sample is determined from the working curve of standard polystyrene prepared and measured in advanced.

Device used: HLC-8320GPC EcoSEC (equipped with an RI detector and a UV detector), TOSOH Corporation

Guard column: TOSOH TSK guardcolumn HXL-H (6.0 mm I.D.×4.0 cm)×1

Column: (reference side) TOSOH TSKgel Super H-RC (6.0 mm I.D.×15 cm)×2

(sample side) TOSOH TSKgel GMHXL (7.8 mm I.D.×30 cm)×2

Column temperature: 40° C.

Mobile phase: chloroform

Flow rate of mobile phase: S.PUMP 1.0 mL/min
R.PUMP 0.5 mL/min

Detector: UV detector

Wavelength: 254 nm

Injection amount: 15 μL

Measurement time: 10-32 min

Run time: 23 min

Sampling pitch: 500 msec

Standard polystyrene samples for working curve: product name “shodex,” manufactured by Showa Denko K.K., weight average molecular weight: 5,620,000, 3,120,000, 1,250,000, 442,000, 131,000, 54,000, 20,000, 7,590, 3,450, 1,320

To produce the working curve, the above polystyrenes for the working curve are grouped into group A (5,620,000, 1,250,000, 131,000, 20,000, and 3,450) and group B (3,120,000, 442,000, 54,000, 7,590, and 1,320).

The samples in group A (5,620,000, 1,250,000, 131,000, 20,000, and 3,450) are weighed one after another (2 mg, 3 mg, 4 mg, 10 mg, and 10 mg) and dissolved in 30 mL of chloroform containing 0.1% by weight of BHT.

The samples in group B (3,120,000, 442,000, 54,000, 7,590, and 1,320) are weighed one after another (3 mg, 4 mg, 8 mg, 10 mg, and 10 mg) and dissolved in 30 mL of chloroform containing 0.1% by weight of BHT.

The measurement is performed using 50 μL of the samples in group A and group B, and a calibration curve (a cubic polynomial) is produced using the measured retention times to produce the working curve.

In the foamed aromatic polyester-based resin particles of the present invention, the content of residual carbon dioxide remaining in the foamed aromatic polyester-based resin particles 7 hours after completion of impregnation of the foamed aromatic polyester-based resin particles with carbon dioxide, i.e., after the particles are impregnated with carbon dioxide for 24 hours under the conditions of 25° C. and 1 MPa, is limited to 5% by weight or more and is preferably 10% by weight or more and more preferably 15% by weight or more.

The foamed aromatic polyester-based resin particles can retain the foaming gas stably for a long time and have a long moldable life (shelf life). In addition, the foamed aromatic polyester-based resin particles produce sufficient foaming pressure during in-mold foam molding, and therefore secondary foamed particles are heat-fused sufficiently, so that an in-mold foam molded product having high mechanical strength and good appearance can be obtained.

The residual carbon dioxide content (after 7 hours) in the foamed aromatic polyester-based resin particles can be measured in the following manner. First, the weight W₁ of the foamed aromatic polyester-based resin particles is measured.

Next, the foamed aromatic polyester-based resin particles are supplied to an autoclave to impregnate the foamed aromatic polyester-based resin particles with carbon dioxide under the conditions of 25° C. and 1 MPa for 24 hours.

The foamed aromatic polyester-based resin particles impregnated with carbon dioxide (hereinafter referred to as “carbon dioxide-impregnated foamed particles”) are removed from the autoclave, and the weight W₂ of the carbon dioxide-impregnated foamed particles is measured within 30 seconds after removal.

Then the carbon dioxide-impregnated foamed particles are left to stand at 25° C. under atmospheric pressure for 7 hours, and the weight W₃ of the carbon dioxide-impregnated foamed particles after a lapse of 7 hours is measured.

Then the residual carbon dioxide content (after 7 hours) in the foamed aromatic polyester-based resin particles is computed from the following formulas.

The amount of impregnation with carbon dioxide immediately after impregnation W₄=W₂−W₁

The amount of impregnation with carbon dioxide after a lapse of 7 hours W₅=W₃−W₁

The residual carbon dioxide content (after 7 hours)=100×W₅/W₄

The foamed aromatic polyester-based resin particles of the present invention can be produced, for example, by a production method including the step of supplying the aromatic polyester-based resin to an extruder to melt and knead the aromatic polyester-based resin in the presence of a foaming agent, the step of, while an extrudate of the aromatic polyester-based resin extruded from a nozzle die attached to the front end of the extruder is extrusion-foamed, cutting the extrudate of the aromatic polyester-based resin to produce particle-shaped cut products, and the step of cooling the particle-shaped cut products. This production method is also an aspect of the present invention. This production method will next be described, but the method of producing the foamed aromatic polyester-based resin particles of the present invention is not limited to the following method.

First, a description will be given of an exemplary production apparatus used to produce the foamed aromatic polyester-based resin particles. In FIG. 1, a nozzle die 1 is attached to the front end of an extruder. The nozzle die 1 is preferred because the aromatic polyester-based resin can be extrusion-foamed to form uniform fine cells. As shown in FIG. 2, a plurality of outlet ports 11, 11, . . . are formed on a front end face 1a of the nozzle die 2 at regular intervals on a single virtual circle A. No particular limitation is imposed on the nozzle die attached to the front end of the extruder, so long as the aromatic polyester-based resin is not foamed within the nozzles.

If the number of nozzles in the nozzle die 1 is small, the efficiency of production of the foamed aromatic polyester-based resin particles becomes low. If the number of nozzles in the nozzle die 1 is large, extrudates of the aromatic polyester-based resin extrusion-foamed through adjacent nozzles may come into contact with each other and coalesce, or particle-shaped cut products obtained by cutting the extrudates of the aromatic polyester-based resin may coalesce. Therefore, the number of nozzles of the nozzle die 1 is preferably 2 to 80, more preferably 5 to 60, and particularly preferably 8 to 50.

If the diameter of the outlet ports 11 of the nozzles of the nozzle die 1 is small, extrusion pressure may become too high, so that it is difficult to perform extrusion foaming. If the diameter of the outlet ports 11 of the nozzles of the nozzle die 1 is large, the diameter of the foamed aromatic polyester-based resin particles may become too large, so that their mold fillability deteriorates. Therefore, the diameter of the outlet ports 11 of the nozzles of the nozzle die 1 is preferably 0.2 to 2 mm, more preferably 0.3 to 1.6 mm, and particularly preferably 0.4 to 1.2 mm.

The length of a land section of the nozzle die 1 is preferably 4 to 30 times the diameter of the outlet ports 11 of the nozzles of the nozzle die 1 and more preferably 5 to 20 times the diameter of the outlet ports 11 of the nozzles of the nozzle die 1. This is because, if the length of the land section of the nozzle die is small relative to the diameter of the outlet ports of the nozzles of the nozzle die, fracture may occur, so that extrusion foaming may not be performed stably. In addition, if the length of the land section of the nozzle die is large relative to the diameter of the outlet ports of the nozzles of the nozzle die, excessively high pressure may be applied to the nozzle die, so that extrusion foaming may not be performed.

A rotation shaft 2 is disposed in a portion surrounded by the outlet ports 11 of the nozzles at the front end face 1a of the nozzle die 1 so as to protrude forward. The rotation shaft 2 passes through a front section 41a of a cooling drum 41 constituting a cooling component 4 described later and is connected to a driving component 3 such as a motor.

In addition, one or a plurality of rotary blades 5 are disposed integrally with the outer circumferential surface of the rear end portion of the rotation shaft 2. When the rotary blades 5 rotate, all the rotary blades 5 are always in contact with the front end face 1a of the nozzle die 1. When a plurality of rotary blades 5 are disposed integrally with the rotation shaft 2, the plurality of rotary blades 5 are arranged at regular intervals in the circumferential direction of the rotation shaft 2. In the example shown in FIG. 2, four rotary blades 5 are disposed integrally with the outer circumferential surface of the rotation shaft 2.

In this configuration, when the rotation shaft 2 rotates, the rotary blades 5 move on the virtual circle A on which the outlet ports 11 of the nozzles are formed while being always in contact with the front end face 1a of the nozzle die 1, so that the rotary blades 5 are capable of sequentially and continuously cutting the extrudates of the aromatic polyester-based resin extruded from the outlet ports 11 of the nozzles.

The cooling component 4 is disposed so as to surround the rotation shaft 2 and at least the front end portion of the nozzle die 1. The cooling component 4 includes a closed-end tubular cooling drum 41 including: a front section 41a having a circular front shape with a diameter larger than the diameter of the nozzle die 1; and a tubular circumferential wall section 41b extending rearward from the outer circumferential edge of the front section 41a.

A supply port 41c for supplying a coolant 42 is formed in a portion of the circumferential wall section 41b of the cooling drum 41 that corresponds to the exterior of the nozzle die 1 so as to pass through the inner and outer circumferential surfaces of the circumferential wall section 41b. A supply tube 41d for supplying the coolant 42 to the cooling drum 41 is connected to the outer opening of the supply port 41c of the cooling drum 41.

In this configuration, the coolant 42 is supplied, through the supply tube 41d, obliquely forward along the inner circumferential surface of the circumferential wall section 41b of the cooling drum 41. Then the coolant 42 flows forward while the coolant 42 is caused to describe a helix along the inner circumferential surface of the circumferential wall section 41b of the cooling drum 41 by the centrifugal force caused by the flow rate of the coolant 42 when it is supplied from the supply tube 41d to the inner circumferential surface of the circumferential wall section 41b of the cooling drum 41. In this configuration, while flowing along the inner circumferential surface of the circumferential wall section 41b, the coolant 42 spreads gradually in a direction perpendicular to its flowing direction, so that the portion of the inner circumferential surface of the circumferential wall section 41b that is frontward of the supply port 41c of the cooling drum 41 is entirely covered with the coolant 42.

No particular limitation is imposed on the coolant 42 so long as it can cool the foamed aromatic polyester-based resin particles, and examples thereof include water and alcohol. In consideration of treatment after use, water is preferred.

A discharge port 41e is formed on the lower surface of the front end portion of the circumferential wall section 41b of the cooling drum 41 so as to pass through the inner and outer circumferential surfaces of the circumferential wall section 41b. A discharge tube 41f is connected to the outer opening of the discharge port 41e. In this configuration, the foamed aromatic polyester-based resin particles and the coolant 42 are continuously discharged through the discharge port 41e.

Preferably, the foamed aromatic polyester-based resin particles are produced by extrusion foaming. For example, the aromatic polyester-based resin is supplied to the extruder and melted and kneaded in the presence of a foaming agent. Then, while the extrudates of the aromatic polyester-based resin extruded from the nozzle die 1 attached to the front end of the extruder 1 are extrusion-foamed, the extrudates are cut by the rotary blades 5 to thereby produce the foamed aromatic polyester-based resin particles.

No particular limitation is imposed on the extruder so long as it is a conventionally used general extruder. Examples of such an extruder may include a single screw extruder, a twin screw extruder, and a tandem extruder including a plurality of connected extruders.

Any conventionally used foaming agent may be used as the above foaming agent. Examples of the foaming agent may include: chemical foaming agents such as azodicarbonamide, dinitrosopentamethylenetetramine, hydrazoyl dicarbonamide, and sodium bicarbonate; and physical foaming agents such as saturated aliphatic hydrocarbons, for example, propane, n-butane, isobutane, n-pentane, isopentane, and hexane, ethers, for example, dimethyl ether, chlorofluorocarbons, for example, methyl chloride, 1,1,1,2-tetrafluoroethane, 1,1-difluoroethane, and monochlorodifluoromethane, carbon dioxide, and nitrogen. Of these, dimethyl ether, propane, n-butane, isobutane, and carbon dioxide are preferred, propane, n-propane, and isobutane are more preferred, and n-butane and isobutane are particularly preferred. Only one type of foaming agent may be used, or a combination of two or more types may be used.

If the amount of the foaming agent to be supplied to the extruder is small, the foamed aromatic polyester-based resin particles may not be foamed to a desired expansion ratio. If the amount of the foaming agent to be supplied to the extruder is large, the viscoelasticity of the aromatic polyester-based resin in a molten state becomes excessively low because the foaming agent acts as a plasticizer, and the foamability of the aromatic polyester-based resin deteriorates, so that favorable foamed aromatic polyester-based resin particles may not be obtained. Therefore, the amount of the foaming agent to be supplied to the extruder based on 100 parts by weight of the aromatic polyester-based resin is preferably 0.1 to 5 parts by weight, more preferably 0.2 to 4 parts by weight, and particularly preferably 0.3 to 3 parts by weight.

Preferably, a cell regulator is supplied to the extruder. The cell regulator is preferably polytetrafluoroethylene powder, polytetrafluoroethylene powder modified by an acrylic resin, talc, etc.

If the amount of the cell regulator to be supplied to the extruder is small, the cells in the foamed aromatic polyester-based resin particles may become excessively large, so that the appearance of an in-mold foam molded product to be obtained may deteriorate. If the amount of the cell regulator to be supplied to the extruder is large, the cells are broken during extrusion foaming of the aromatic polyester-based resin, so that the closed cell ratio of the foamed aromatic polyester-based resin particles may become small. Therefore, the amount of the cell regulator to be supplied to the extruder based on 100 parts by weight of the aromatic polyester-based resin is preferably 0.01 to 5 parts by weight, more preferably 0.05 to 3 parts by weight, and particularly preferably 0.1 to 2 parts by weight.

Then the extrudates of the aromatic polyester-based resin extrusion-foamed through the nozzle die 1 are subjected to the cutting step. The extrudates of the aromatic polyester-based resin are cut by rotating the rotary blades 5 disposed on the front end face 1a of the nozzle die 1 by means of the rotation of the rotation shaft 2. The rotation speed of the rotary blades 5 is preferably 2,000 to 10,000 rpm. Preferably, the rotary blades are rotated at constant speed.

The rotary blades 5 rotate while all the rotary blades 5 are always in contact with the front end face 1a of the nozzle die 1. The extrudates of the aromatic polyester-based resin extrusion-foamed through the nozzle die 1 are cut in the air at regular time intervals by shear stress generated between the rotary blades 5 and the edges of the outlet ports 11 of the nozzles of the nozzle die 1, whereby particle-shaped cut products are produced. In this case, water may be sprayed onto the extrudates of the aromatic polyester-based resin so long as the extrudates of the aromatic polyester-based resin are not excessively cooled.

In the present invention, the aromatic polyester-based resin is prevented from being foamed within the nozzles of the nozzle die 1. The aromatic polyester-based resin remains unfoamed immediately after ejected from the outlet ports 11 of the nozzles of the nozzle die 1 and starts foaming a short time after ejection. Therefore, the extrudates of the aromatic polyester-based resin include unfoamed portions formed immediately after ejection from the outlet ports 11 of the nozzles of the nozzle die 1 and foamed portions that are continuous with the unfoamed portions, extruded ahead of the unfoamed portions, and being foamed.

The unfoamed portions maintain their state from ejection from the outlet ports 11 of the nozzles of the nozzle die 1 until they start foaming. The time during which the unfoamed portions are maintained can be controlled by adjusting the pressure of the resin at the outlet ports 11 of the nozzles of the nozzle die 1, the amount of the foaming agent, etc. If the pressure of the resin at the outlet ports 11 of the nozzles of the nozzle die 1 is high, the extrudates of the aromatic polyester-based resin are not foamed immediately after extrusion from the nozzle die 1 and maintain the unfoamed state. The pressure of the resin at the outlet ports 11 of the nozzles of the nozzle die 1 can be controlled by adjusting the diameter of the nozzles, the rate of extrusion, the melt viscosity of the aromatic polyester-based resin, and its melt tension. By adjusting the amount of the foaming agent to a proper amount, the aromatic polyester-based resin is prevented from being foamed within the die, so that the unfoamed portions can be formed in a reliable manner.

Since the rotary blades 5 cut the extrudates of the aromatic polyester-based resin while all the rotary blades 5 are always in contact with the front end face 1a of the nozzle die 1, the extrudates of the aromatic polyester-based resin are cut at the unfoamed portions formed immediately after ejection from the outlet ports 11 of the nozzles of the nozzle die 1, whereby particle-shaped cut products are produced.

As described above, the rotary blades 5 rotate at constant rotation speed. The rotation speed of the rotary blades 5 is preferably 2,000 to 10,000 rpm, more preferably 2,000 to 9,000 rpm, and particularly preferably 2,000 to 8,000 rpm.

This is because, if the rotary blades 5 rotate at rotation speed lower than 2,000 rpm, the extrudates of the aromatic polyester-based resin cannot be cut by the rotary blades 5 in a reliable manner, so that the particle-shaped cut products may coalesce or the shapes of the particle-shaped cut products may become nonuniform.

If the rotation speed of the rotary blades 5 is higher than 10,000 rpm, the following problems tend to occur. A first problem is as follows. The cutting stress by the rotary blades becomes large, so that, when the particle-shaped cut products fly from the outlet ports of the nozzles toward the cooling component, the initial velocity of the particle-shaped cut products becomes high. As a result, the time from when the particle-shaped cut products are cut until they collide with the cooling component becomes short, so that the particle-shaped cut products may be foamed insufficiently. In this case, the expansion ratio of the obtained foamed aromatic polyester-based resin particles becomes low. A second problem is that wear of the rotary blades and the rotation shaft becomes large, so that the life of the rotary blades and the rotation shaft may become short.

The cutting stress by the rotary blades 5 causes the particle-shaped cut products obtained as described above to fly toward the cooling drum 41 at the same time when they are cut, and then the particle-shaped cut products immediately collide with the coolant 42 that covers the inner circumferential surface of the circumferential wall section 41b of the cooling drum 41. The particle-shaped cut products continue foaming until they collide with the coolant 42, and the foaming causes the particle-shaped cut products to grow into a substantially spherical shape. Therefore, the obtained foamed aromatic polyester-based resin particles are substantially spherical. The foamed aromatic polyester-based resin particles can be easily filled into a mold. Therefore, when the mold is filled with the foamed aromatic polyester-based resin particles to perform in-mold foaming, the foamed aromatic polyester-based resin particles can be uniformly filled into the mold, so that a uniform in-mold foam molded product can be obtained.

The inner circumferential surface of the circumferential wall section 41b of the cooling drum 41 is entirely covered with the coolant 42. More specifically, the coolant 42 is supplied, through the supply tube 41d, obliquely forward along the inner circumferential surface of the circumferential wall section 41b of the cooling drum 41. Then the coolant 42 flows forward while the coolant 42 is caused to describe a helix along the inner circumferential surface of the circumferential wall section 41b of the cooling drum 41 by the centrifugal force caused by the flow rate of the coolant 42 when it is supplied from the supply tube 41d to the inner circumferential surface of the circumferential wall section 41b of the cooling drum 41. Then while flowing along the inner circumferential surface of the circumferential wall section 41b, the coolant 42 spreads gradually in a direction perpendicular to its flowing direction, so that the portion of the inner circumferential surface of the circumferential wall section 41b that is frontward of the supply port 41c of the cooling drum 41 is entirely covered with the coolant 42.

Since the particle-shaped cut products are cooled by the coolant 42 immediately after the extrudates of the aromatic polyester-based resin are cut by the rotary blades 5 as described above, the foamed aromatic polyester-based resin particles are prevented from being foamed excessively.

In addition, the particle-shaped cut products obtained by cutting the extrudates of the aromatic polyester-based resin by the rotary blades 5 are caused to fly toward the coolant 42. As described above, the coolant 42 flowing along the inner circumferential surface of the circumferential wall section 41b of the cooling drum 41 flows while turning helically. Therefore, it is preferable that the particle-shaped cut products P be allowed to collide with the coolant 42 in a direction oblique to the surface of the coolant 42 from the upstream side of the flow of the coolant 42 toward the downstream side and then to enter the coolant 42 (see FIG. 3). In FIG. 3, the direction of the flow of the coolant is denoted by “F.”

As described above, when the particle-shaped cut products enter the coolant 42, the particle-shaped cut products are caused to enter the coolant 42 in the direction along the flow of the coolant 42. Therefore, the particle-shaped cut products are not bounced from the surface of the coolant 42 but enter the coolant 42 smoothly in a reliable manner and are cooled by the coolant 42, whereby the foamed aromatic polyester-based resin particles are produced.

Therefore, the foamed aromatic polyester-based resin particles have a substantially spherical shape with no cooling unevenness and no shrinkage and exhibit high foamability during in-mold foam molding. Even when a crystalline resin such as polyethylene terephthalate is used, the degree of increase in crystallinity is small because the particle-shaped cut products are cooled immediately after the extrudates of the aromatic polyester-based resin are cut. Since the degree of crystallinity of the foamed aromatic polyester-based resin particles is small, they have high heat-fusion bondability, so that an in-mold foam molded product to be obtained has high mechanical strength. The degree of crystallinity of the foamed aromatic polyester-based resin particles can be increased during in-mold foam molding to improve the heat resistance of the aromatic polyester-based resin, so that the obtained in-mold foam molded product has high heat resistance.

If the temperature of the coolant 42 is low, the nozzle die located in the vicinity of the cooling drum 41 is cooled excessively, and this may cause an adverse effect on extrusion foaming of the aromatic polyester-based resin. If the temperature of the coolant 42 is high, the particle-shaped cut products may be cooled insufficiently. Therefore, the temperature of the coolant 42 is preferably 10 to 40° C.

If the bulk density of the foamed aromatic polyester-based resin particles is small, the open cell ratio of the foamed aromatic polyester-based resin particles increases, so that the required foaming power may not be provided to the foamed aromatic polyester-based resin particles during foaming in in-mold foam molding. If the bulk density of the foamed aromatic polyester-based resin particles is large, the cells of the obtained foamed aromatic polyester-based resin particles become nonuniform, so that the foamability of the foamed aromatic polyester-based resin particles during in-mold foam molding may become insufficient. Therefore, the bulk density of the foamed aromatic polyester-based resin particles is preferably 0.05 to 0.7 g/cm³, more preferably 0.07 to 0.6 g/cm³, and particularly preferably 0.08 to 0.5 g/cm³. The bulk density of the foamed aromatic polyester-based resin particles can be controlled by adjusting the pressure of the resin at the outlet ports 11 of the nozzles of the nozzle die 1, the amount of the foaming agent, etc. The pressure of the resin at the outlet ports 11 of the nozzles of the nozzle die 1 can be controlled by adjusting the diameter of the nozzles, the rate of extrusion, and the melt viscosity of the aromatic polyester-based resin.

The bulk density of the foamed aromatic polyester-based resin particles is a value measured according to JIS K6911: 1995 “Testing methods for thermosetting plastics.”

More specifically, measurement is performed using an apparent density meter according to JIS K6911, and then the bulk density of the foamed aromatic polyester-based resin particles can be measured on the basis of the following formula.

Bulk density (g/cm³) of foamed aromatic polyester-based resin particles=[mass (g) of measuring cylinder containing sample−mass (g) of measuring cylinder]/[volume (cm³) of measuring cylinder]

The obtained foamed aromatic polyester-based resin particles are formed by cutting the extrudates of the aromatic polyester-based resin at their unfoamed portions. No cross sections of cells are present on the cut surfaces of the extrudates of the aromatic polyester-based resin. Even though cross sections of cells are present, the number of cross sections of cells is very small. Therefore, no cross sections of cells are present on the entire surfaces of the obtained foamed aromatic polyester-based resin particles, or only a very small number of cross sections of cells are present. Accordingly, the foamed aromatic polyester-based resin particles have high foamability without loss of the foaming gas and also have a low open cell ratio and high heat-fusion bondability at their surfaces.

As shown in FIG. 4, each foamed aromatic polyester-based resin particle A includes a foamed aromatic polyester-based resin particle main body A1 and an unfoamed skin layer A2 that covers the surface of the foamed aromatic polyester-based resin particle main body A1. The “foamed aromatic polyester-based resin particle main body” may be referred to simply as a “foamed particle main body.”

Since each foamed aromatic polyester-based resin particle A is produced by extrusion foaming of the aromatic polyester-based resin, the foamed particle main body A1 contains cells not only in its surface portion but also in the central portion and therefore contains fine cells distributed over its entire volume. Therefore, when the foamed aromatic polyester-based resin particles are subjected to secondary foaming during in-mold foam molding, the foamed particle main bodies are entirely expanded by foaming, so that the foamed aromatic polyester-based resin particles A have high foamability. The foamed aromatic polyester-based resin particles A produce high foaming pressure during secondary foaming. Therefore, secondary foamed particles obtained by secondary foaming of the foamed aromatic polyester-based resin particles A are firmly heat-fused and integrated with each other, and the obtained in-mold foam molded product has high mechanical strength.

The surface of each foamed aromatic polyester-based resin particle A is coated with the unfoamed skin layer A2. Therefore, no cross sections of cells or only a small number of cross sections of cells are present on the surfaces of the foamed aromatic polyester-based resin particles. When the foamed aromatic polyester-based resin particles are used for in-mold foam molding, the heat-fusion bondability between the foamed particles is high. Therefore, the obtained in-mold foam molded product has no surface unevenness, and almost no cross sections of cells are present on its surface, so that the in-mold foam molded product has good appearance and high mechanical strength.

As described above, the entire or most of the surface of each of the obtained foamed aromatic polyester-based resin particles is covered with the unfoamed skin layer A2, and no cross sections of cells or only a small number of cross sections of cells are present on the surfaces of the foamed aromatic polyester-based resin particles. Therefore, the open cell ratio of the foamed aromatic polyester-based resin particles is low, and their foaming gas retention ability is high.

More specifically, the surface coverage of the foamed aromatic polyester-based resin particle A with the skin layer A2 is preferably 80% or higher and more preferably 95 to 100%. Since the surface coverage is 80% or higher, no cross sections of cells or only a small number of cross sections of cells appear on the surfaces of the foamed aromatic polyester-based resin particles. Therefore, the foamed aromatic polyester-based resin particles of the present invention can retain the foaming gas stably for a long time, and therefore the moldable life (shelf life) is long. The foamed aromatic polyester-based resin particles of the present invention produce sufficient foaming pressure during in-mold foam molding, so that the foamed particles are sufficiently heat-fused with each other. Therefore, an in-mold foam molded product having high mechanical strength and good appearance can be obtained. In the foamed aromatic polyester-based resin particles, the surface coverage with the skin layer A2 can be controlled by adjusting the temperature of the aromatic polyester-based resin extrusion-foamed from the extruder, the amount of the foaming agent supplied to the extruder, the amount of the cross-linking agent supplied to the extruder, etc.

When the surface coverage is 80% or higher, the foamed aromatic polyester-based resin particles have high heat-fusion bondability. When these foamed aromatic polyester-based resin particles are used for in-mold foam molding, the foamed particles are firmly heat-fused and integrated with each other because of their foaming pressure, so that the obtained in-mold foam molded product has high mechanical strength.

The surface coverage of the foamed aromatic polyester-based resin particles is a value measured in the following manner. First, 20 foamed aromatic polyester-based resin particles are arbitrarily extracted. For each of the foamed aromatic polyester-based resin particles, photographs of its front view, plan view, bottom view, rear view, left side view, and right side view are taken by an orthogonal projection method at a magnification of 10 to 20 times such that the magnifications of the photographs are the same.

Next, for each of the foamed aromatic polyester-based resin particles, the total S₁ of the areas of the foamed aromatic polyester-based resin particle in the six photographs is computed, and each of the photographs is visually observed to compute the total S₂ of the areas of portions in which cell membranes are recognized. The portions in which cells are recognized include both the cell membranes themselves and portions surrounded by cell membranes in the photographs. The surface coverage with the skin layer is computed for each foamed aromatic polyester-based resin particle using the following formula, and the arithmetic mean of the surface coverage values of the foamed aromatic polyester-based resin particles is used as the surface coverage of the foamed aromatic polyester-based resin particles.

Surface coverage (%)=100×S₂/S₁

As described above, the entire surface of each the obtained foamed aromatic polyester-based resin particles A is covered with the skin layer A2, and no cross sections of cells or only a small number of cross section of cells are present on the surfaces of the foamed aromatic polyester-based resin particles A. Therefore, the foamed aromatic polyester-based resin particles A have a low open cell ratio and high foaming gas retention ability.

If the open cell ratio of the foamed aromatic polyester-based resin particles is high, the foaming gas retention ability deteriorates, and the foaming pressure of the foamed particles during in-mold foam molding becomes insufficient, so that the heat-fusion bonding between the secondary foamed particles becomes insufficient. In this case, the mechanical strength and appearance of the in-mold foam molded product may deteriorate. Therefore, the open cell ratio of the foamed aromatic polyester-based resin particles is preferably less than 15%, more preferably 10% or less, and particularly preferably 7% or less. The open cell ratio of the foamed aromatic polyester-based resin particles is controlled by adjusting the temperature of the aromatic polyester-based resin extrusion-foamed from the extruder, the amount of the foaming agent supplied to the extruder, etc.

The open cell ratio of the foamed aromatic polyester-based resin particles is measured in the following manner. First, a sample cup of a volume measurement air comparison pycnometer is prepared, and the total weight A (g) of the foamed aromatic polyester-based resin particles that fill about 80% of the sample cup is measured. Next, the total volume B (cm³) of the foamed aromatic polyester-based resin particles is measured by a 1-1/2-1 pressure method using the pycnometer. The volume measurement air comparison pycnometer is commercially available, for example, under the product name “type 1000” from Tokyo science Co., Ltd.

Next, a wire net-made container is prepared. The wire net-made container is immersed in water, and the weight C (g) of the wire net-made container immersed in water is measured. Then the entire amount of the foamed aromatic polyester-based resin particles is placed in the wire net-made container, and the wire net-made container is immersed in water. The total D (g) of the weight of the wire net-made container immersed in water and the weight of the foamed aromatic polyester-based resin particles placed in the wire net-made container is measured.

The apparent volume E (cm³) of the foamed aromatic polyester-based resin particles is computed using a formula below. The open cell ratio of the foamed aromatic polyester-based resin particles can be computed from the apparent volume E and the total volume B (cm³) of the foamed aromatic polyester-based resin particles using a formula below. The volume of 1 g of water is assumed to be 1 cm³.

E=A+(C−D)

Open cell ratio (%)=100×(E−B)/E

If the sphericity of the foamed aromatic polyester-based resin particles is small, the mold is not uniformly filled with the foamed aromatic polyester-based resin particles during in-mold foam molding, so that heat-fusion bonding between the foamed particles in the obtained in-mold foam molded product may be partially insufficient. Therefore, the sphericity of the foamed aromatic polyester-based resin particles is preferably 0.7 or more and more preferably 0.8 or more. The sphericity of the foamed aromatic polyester-based resin particles can be controlled by adjusting the rotation speed of the rotary blades, the diameter of the nozzles, the rate of extrusion, etc.

The sphericity of the foamed aromatic polyester-based resin particles is measured in the following manner. Fifty foamed aromatic polyester-based resin particles are arbitrarily extracted. For each of the foamed aromatic polyester-based resin particles, its maximum length and minimum length are measured. The sphericity of each of the foamed aromatic polyester-based resin particles is computed from the measured values using the following formula.

Sphericity=(minimum length)/(maximum length)

Then the arithmetic mean of the sphericity values of the 50 foamed aromatic polyester-based resin particles is used as the sphericity of the foamed aromatic polyester-based resin particles.

If the degree of crystallinity of the foamed aromatic polyester-based resin particles is high, the heat-fusion bondability between the foamed particles may deteriorate during in-mold foam molding. Therefore, the degree of crystallinity is preferably less than 15% and more preferably 10% or less. The degree of crystallinity of the foamed aromatic polyester-based resin particles can be controlled by adjusting the temperature of the coolant 42 or the time from extrusion of the extrudates of the aromatic polyester-based resin from the nozzle die 1 until the particle-shaped cut products collide with the coolant 42.

The degree of crystallinity of the foamed aromatic polyester-based resin particles can be computed using a differential scanning calorimeter (DSC) according to a measurement method described in JIS K7121. More specifically, the degree of crystallinity can be computed from the amount of heat of crystallization per 1 mg and the amount of heat of fusion per 1 mg that are measured while the foamed aromatic polyester-based resin particles are heated at a heating rate of 10° C./minute. ΔH₀ means the theoretical amount of heat of fusion [the amount of heat of fusion of fully crystallized particles (a theoretical value)] when the degree of crystallinity is 100%. For example, ΔH₀ of polyethylene terephthalate is 140.1 mJ/mg.

Degree of crystallinity (%)=100×(|amount of heat of fusion (mJ/mg)|−|amount of heat of crystallization (mJ/mg)|)/ΔH₀

By filling a cavity of a mold with the foamed aromatic polyester-based resin particles of the present invention and heating the foamed aromatic polyester-based resin particles to foam them, the secondary foamed particles obtained by foaming the foamed aromatic polyester-based resin particles are heat-fused and integrated with each other through their foaming pressure, whereby an in-mold foam molded product having high heat-fusion bondability and also having a desired shape can be obtained. When a crystalline aromatic polyester-based resin such as polyethylene terephthalate is used, an in-mold foam molded product having high heat resistance can be obtained by increasing the degree of crystallinity of the aromatic polyester-based resin. No particular limitation is imposed on a heating medium for the foamed aromatic polyester-based resin particles filled into the mold, and examples of the heating medium may include, in addition to water vapor, hot air and warm water.

An in-mold foam molded product obtained by in-mold foam molding using the foamed aromatic polyester-based resin particles of the present invention is also an aspect of the present invention.

Before in-mold foam molding, the foamed aromatic polyester-based resin particles may be impregnated with an inert gas to improve the foaming power of the foamed aromatic polyester-based resin particles. By improving the foaming power of the foamed aromatic polyester-based resin particles as described above, the heat-fusion bondability between the foamed aromatic polyester-based resin particles during in-mold foam molding is improved, and the obtained in-mold foam molded product has higher mechanical strength. Examples of the inert gas may include carbon dioxide, nitrogen, helium, and argon, and carbon dioxide is preferred.

Examples of the method of impregnating the foamed aromatic polyester-based resin particles with the inert gas may include a method in which the foamed aromatic polyester-based resin particles are placed in an inert gas atmosphere with a pressure equal to or higher than atmospheric pressure to impregnate the foamed aromatic polyester-based resin particles with the inert gas. In this case, the foamed aromatic polyester-based resin particles may be impregnated with the inert gas before they are filled into the mold. However, the foamed aromatic polyester-based resin particles may be first filled into the mold, and then the mold filled with the foamed aromatic polyester-based resin particles may be placed in an inert gas atmosphere to impregnate the foamed aromatic polyester-based resin particles with the inert gas.

The temperature when the foamed aromatic polyester-based resin particles are impregnated with the inert gas is preferably 5 to 40° C. and more preferably 10 to 30° C. This is because, if the temperature is low, the foamed aromatic polyester-based resin particles are cooled excessively, so that the foamed aromatic polyester-based resin particles cannot be heated sufficiently during in-mold foam molding. In this case, the heat-fusion bondability between the foamed aromatic polyester-based resin particles may deteriorate, and the mechanical strength of the obtained in-mold foam molded product may decrease. If the temperature is high, the amount of the inert gas with which the foamed aromatic polyester-based resin particles are impregnated becomes low, so that sufficient foamability may not be imparted to the foamed aromatic polyester-based resin particles. In addition, crystallization of the foamed aromatic polyester-based resin particles is facilitated, and the heat-fusion bondability between the foamed aromatic polyester-based resin particles deteriorates, so that the mechanical strength of the obtained in-mold foam molded product may decrease.

The pressure when the foamed aromatic polyester-based resin particles are impregnated with the inert gas is preferably 0.2 to 2.0 MPa and more preferably 0.25 to 1.5 MPa. When the inert gas is carbon dioxide, the pressure is preferably 0.2 to 1.5 MPa and more preferably 0.25 to 1.2 MPa. This is because, if the pressure is low, the amount of the inert gas with which the foamed aromatic polyester-based resin particles are impregnated becomes low, so that sufficient foamability cannot be imparted to the foamed aromatic polyester-based resin particles. In this case, the mechanical strength of the obtained in-mold foam molded product may decrease.

If the pressure is high, the degree of crystallinity of the foamed aromatic polyester-based resin particles increases, so that the heat-fusion bondability between the foamed aromatic polyester-based resin particles deteriorates. In this case, the mechanical strength of the obtained in-mold foam molded product may decrease.

The time during which the foamed aromatic polyester-based resin particles are impregnated with the inert gas is preferably 10 minutes to 72 hours, more preferably 15 minutes to 64 hours, and particularly preferably 20 minutes to 48 hours. When the inert gas is carbon dioxide, the time is preferably 20 minutes to 24 hours. This is because, when the impregnation time is short, the foamed aromatic polyester-based resin particles cannot be sufficiently impregnated with the inert gas. If the impregnation time is long, the efficiency of production of the in-mold foam molded product deteriorates.

By impregnating the foamed aromatic polyester-based resin particles with the inert gas at 5 to 40° C. and a pressure of 0.2 to 2.0 MPa as described above, the foamability of the foamed aromatic polyester-based resin particles can be improved while an increase in their degree of crystallinity is suppressed. Therefore, the foamed aromatic polyester-based resin particles can be firmly heat-fused and integrated with each other through sufficient foaming power during in-mold foam molding, whereby an in-mold foam molded product having high mechanical strength can be obtained.

The in-mold foam molded product may be molded by, after the foamed aromatic polyester-based resin particles are impregnated with the inert gas in the manner described above, pre-foaming the foamed aromatic polyester-based resin particles to form pre-foamed particles, filling a cavity of a mold with the pre-foamed particles, and heating the pre-foamed particles to foam them. The pre-foamed particles may be further impregnated with the inert gas in the same manner as that when the foamed aromatic polyester-based resin particles are impregnated with the inert gas.

Examples of the method of pre-foaming the foamed aromatic polyester-based resin particles to obtain the pre-foamed particles may include a method in which the foamed aromatic polyester-based resin particles impregnated with the inert gas are heated to 55 to 90° C. to foam them to thereby produce the pre-foamed particles.

A composite structural component can be produced by using an in-mold foam molded product produced in the manner described above as a core, stacking a skin material on the surface of the in-mold foam molded product, and integrating the skin material therewith. The composite structural component including the in-mold foam molded product and the skin material stacked on and integrated with the surface of the in-mold foam molded product is also an aspect of the present invention. The thickness of the in-mold foam molded product used as the core of the composite structural component is preferably 1 to 40 mm in terms of strength, weight, and shock resistance.

No particular limitation is imposed on the skin material, and examples thereof include fiber reinforced synthetic resin sheets, metal sheets, and synthetic resin sheets. The skin material is preferably a fiber reinforced synthetic resin sheet because of its high mechanical strength and light weight.

The fiber reinforced synthetic resin sheet is a sheet obtained by bonding the fibers with each other through a matrix resin. No particular limitation is imposed on the fibers included in the fiber reinforced synthetic resin sheet, and examples thereof may include carbon fibers, glass fibers, aramid fibers, boron fibers, and metal fibers. The fibers are preferably carbon fibers, glass fibers, or aramid fibers because of their high mechanical strength and high heat resistance, and carbon fibers are more preferred.

The matrix resin constituting the fiber reinforced synthetic resin may be a thermosetting resin or a thermoplastic resin. Examples of the thermosetting resin may include epoxy resins, unsaturated polyester resins, and phenolic resins. Only one type of thermosetting resin may be used, or a combination of two or more types thereof may be used. Examples of the thermoplastic resin may include polyamides (nylon 6, nylon 66, etc.), polyolefins (polyethylene, polypropylene, etc.), polyphenylene sulfide, polyethylene terephthalate, polybutylene terephthalate, polycarbonate, polystyrene, ABS, and a copolymer of acrylonitrile and styrene. Only one type of thermoplastic resin may be used, or a combination of two or more types may be used.

The thickness of the fiber reinforced synthetic resin sheet is preferably 0.2 to 2.0 mm from the viewpoint of strength, weight, and shock resistance.

No particular limitation is imposed on the method of producing the composite structural component, and examples thereof may include a method in which the skin material is stacked on and integrated with the surface of the in-mold foam molded product used as the core with an adhesive and methods generally used for molding of the fiber reinforced synthetic resin sheet. Examples of the method of molding the fiber reinforced synthetic resin sheet may include an autoclave method, a hand lay-up method, a spray-up method, a PCM (Prepreg Compression Molding) method, an RTM (Resin Transfer Molding) method, and a VaRTM (Vacuum assisted Resin Transfer Molding) method.

Such a composite structural component is useful for applications such as automobile components, aircraft components, railroad car components, and building materials. Examples of the automobile components may include door panels, door inner components, bumpers, fenders, fender supports, engine covers, roof panels, trunk lids, floor panels, center tunnels, and crash boxes. For example, when the composite structural component is used for a door panel conventionally produced from a steel plate, the door panel can be significantly reduced in weight while substantially the same stiffness as that of the steel plate-made door panel is ensured, so that a high effect of reducing the weight of the automobile can be achieved.

### Advantageous Effects of Invention

The foamed aromatic polyester-based resin particles for in-mold foam molding according to the present invention contain an aromatic polyester-based resin, and the content of residual carbon dioxide 7 hours after the particles are impregnated with carbon dioxide for 24 hours under the conditions of 25° C. and 1 MPa is 5% by weight or more. Therefore, the foamed aromatic polyester-based resin particles for in-mold foam molding according to the present invention have high foaming gas retention ability and provide high foaming power during in-mold foam molding, so that the secondary foamed particles are firmly heat-fused and integrated with each other. With the foamed aromatic polyester-based resin particles for in-mold foam molding according to the present invention, an in-mold foam molded product having high mechanical strength can be obtained.

In the foamed aromatic polyester-based resin particles for in-mold foam molding according to the present invention, when the Z average molecular weight of the aromatic polyester-based resin constituting the foamed aromatic polyester-based resin particles is 2.0×10⁵ or higher, higher foaming gas retention ability is obtained, and high foaming power is achieved during in-mold foam molding, so that the secondary foamed particles are more firmly heat-fused and integrated with each other. With these foamed aromatic polyester-based resin particles for in-mold foam molding according to the present invention, an in-mold foam molded product having higher mechanical strength can be obtained.

In the foamed aromatic polyester-based resin particles for in-mold foam molding, when the open cell ratio is less than 15%, higher foaming gas retention ability is obtained, and more stable foaming power is achieved during in-mold foam molding. Therefore, the secondary foamed particles are firmly heat-fused and integrated with each other, and the obtained in-mold foam molded product has higher mechanical strength.

The foamed aromatic polyester-based resin particles for in-mold foam molding each include a foamed aromatic polyester-based resin particle main body and an unfoamed skin layer that covers the surface of the foamed aromatic polyester-based resin particle main body. When the coverage with the skin layer is 80% or higher, only a small number of cross sections of cells or no cross sections of cells are present on the surfaces of the foamed aromatic polyester-based resin particles. Therefore, the foamed aromatic polyester-based resin particles have higher foaming gas retention ability and higher heat-fusion bondability. The secondary foamed particles are more firmly heat-fused and integrated with each other through their foaming pressure during in-mold foam molding, and the obtained in-mold foam molded product has higher mechanical strength.

As described above, only a small number of cross sections of cells or no cross sections of cells are present on the surfaces of the foamed aromatic polyester-based resin particles for in-mold foam molding. Therefore, cross sections of cells are less likely to appear on the surface of the in-mold foam molded product obtained using the foamed aromatic polyester-based resin particles for in-mold foam molding, and the obtained in-mold foam molded product has good appearance.

When the sphericity of the foamed aromatic polyester-based resin particles for in-mold foam molding is 0.7 or higher, the mold can be substantially uniformly filled with the foamed aromatic polyester-based resin particles for in-mold foam molding during in-mold foam molding. Therefore, the foamed aromatic polyester-based resin particles can be entirely and uniformly foamed, and the secondary foamed particles can be heat-fused and integrated with each other in a more reliable manner. The obtained in-mold foam molded product thereby has higher mechanical strength and better appearance.

When the degree of crystallinity of the foamed aromatic polyester-based resin particles for in-mold foam molding is less than 15%, the foamed particles have higher heat-fusion bondability and are sufficiently heat-fused and integrated with each other during in-mold foam molding. Therefore, the obtained in-mold foam molded product has higher mechanical strength and better appearance.

When the bulk density of the foamed aromatic polyester-based resin particles for in-mold foam molding is 0.05 to 0.7 g/cm³, the foamed aromatic polyester-based resin particles provide higher foaming power during in-mold foam molding, and the secondary foamed particles are firmly heat-fused and integrated with each other. Therefore, the obtained in-mold foam molded product has higher mechanical strength.

The method of producing the foamed aromatic polyester-based resin particles for in-mold foam molding according to the present invention includes the step of supplying the aromatic polyester-based resin to an extruder to melt and knead the aromatic polyester-based resin in the presence of a foaming agent, the step of, while an extrudate of the aromatic polyester-based resin extruded from a nozzle die attached to the front end of the extruder is extrusion-foamed, cutting the extrudate of the aromatic polyester-based resin to produce particle-shaped cut products, and the step of cooling the particle-shaped cut products. Only a small number of cross sections of cells or no cross sections of cells are present on the surfaces of the obtained foamed aromatic polyester-based resin particles. Therefore, the foamed aromatic polyester-based resin particles have higher foaming gas retention ability and higher heat-fusion bondability. During in-mold foam molding, the secondary foamed particles are more firmly heat-fused and integrated with each other through their foaming pressure, and the obtained in-mold foam molded product has higher mechanical strength.

In the method of producing the foamed aromatic polyester-based resin particles, when 100 parts by weight of the aromatic polyester-based resin having an intrinsic viscosity of 0.8 to 1.1 and 0.01 to 5 parts by weight of a cross-linking agent are supplied to the extruder to cross-link the aromatic polyester-based resin with the cross-linking agent, the obtained foamed aromatic polyester-based resin particles have higher foaming gas retention ability. Therefore, the foamed aromatic polyester-based resin particles provide more stable foaming power during in-mold foam molding, and the foamed particles are firmly heat-fused and integrated with each other, so that the obtained in-mold foam molded product has higher mechanical strength.

### BRIEF DESCRIPTION OF DRAWINGS

FIG. 1 is a schematic cross-sectional view illustrating an exemplary apparatus for producing foamed aromatic polyester-based resin particles.

FIG. 2 is a schematic front view of a multi-nozzle die.

FIG. 3 is a schematic diagram illustrating a foamed aromatic polyester-based resin particle entering a coolant.

FIG. 4 is a photograph of a cross section of a foamed aromatic polyester-based resin particle obtained in Example 1, the cross section being observed under a scanning electron microscope (SEM) at 20 times.

FIG. 5 is photograph of the surface of a foamed aromatic polyester-based resin particle obtained in Example 1, the surface being observed under a scanning electron microscope (SEM) at 20 times.

FIG. 6 is a photograph of a foamed aromatic polyester-based resin particle obtained in Comparative Example 1, the particle being observed from the front under a scanning electron microscope (SEM) at 30 times.

FIG. 7 is a photograph of the foamed aromatic polyester-based resin particle obtained in Comparative Example 1, the particle being observed from the side under the scanning electron microscope (SEM) at 30 times.

### DESCRIPTION OF EMBODIMENTS

Examples of the present invention will next be described, but the present invention is not limited to the Examples below.

### Example 1

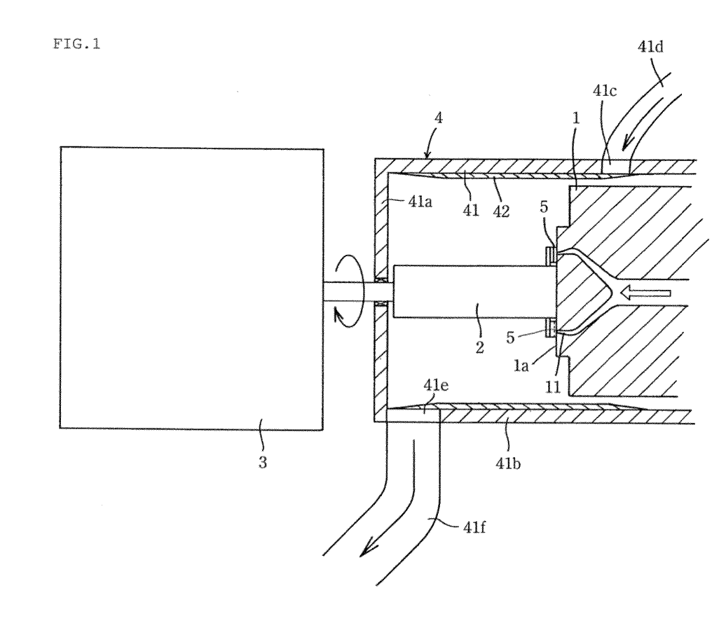

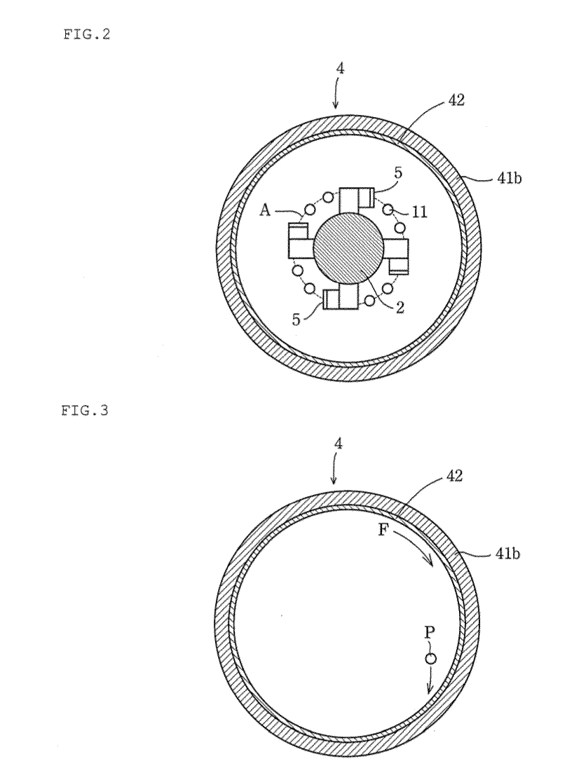

The production apparatus shown in FIGS. 1 and 2 was used. First, a polyethylene terephthalate composition containing 100 parts by weight of polyethylene terephthalate (manufactured by Mitsui Chemicals, Inc., product name “SA-135,” melting point: 247.1° C., intrinsic viscosity: 0.88), 1.8 parts by weight of a master batch prepared by adding talc to polyethylene terephthalate (content of polyethylene terephthalate: 60% by weight, content of talc: 40% by weight, the intrinsic viscosity of polyethylene terephthalate: 0.88), and 0.20 parts by weight of pyromellitic dianhydride was supplied to a single screw extruder having an opening diameter of 65 mm and an LID ratio of 35 and melted and kneaded at 290° C.

Next, butane including 35% by weight of isobutane and 65% by weight of n-butane was injected, in an amount of 0.7 parts by weight based on 100 parts by weight of polyethylene terephthalate, from a mid section of the extruder into the molten polyethylene terephthalate composition and was uniformly dispersed in the polyethylene terephthalate.

Then the molten polyethylene terephthalate composition was cooled to 280° C. at the front end portion of the extruder, and the cooled polyethylene terephthalate composition was extrusion-foamed through the respective nozzles of the multi-nozzle die 1 attached to the front end of the extruder. The rate of extrusion of the polyethylene terephthalate composition was 30 kg/hour.

The multi-nozzle die 1 had 20 nozzles each having an outlet port 11 with a diameter of 1 mm, and all the outlet ports 11 of the nozzles were disposed at regular intervals on a virtual circle A assumed to be present on the front end face 1a of the multi-nozzle die 1 and having a diameter of 139.5 mm.

Two rotary blades 5 were disposed integrally with the outer circumferential surface of the rear end portion of the rotation shaft 2 with a phase difference of 180° in the circumferential direction of the rotation shaft 2. The respective rotary blades 5 were configured so as to move on the virtual circle A while being always in contact with the front end face 1a of the multi-nozzle die 1.

The cooling component 4 had a cooling drum 41 having a front section 41a with a circular front shape and a tubular circumferential wall section 41b extending rearward from the outer circumferential edge of the front section 41a and having an inner diameter of 320 mm. Cooling water 42 at 20° C. was supplied to the cooling drum 41 through the supply tube 41d and the supply port 41c of the cooling drum 41. The volume of the cooling drum 41 was 17,684 cm³.

The coolant 42 flows forward while the coolant 42 is caused to describe a helix along the inner circumferential surface of the circumferential wall section 41b of the cooling drum 41 by the centrifugal force caused by the flow rate of the coolant 42 when it is supplied from the supply tube 41d to the inner circumferential surface of the circumferential wall section 41b of the cooling drum 41. While flowing along the inner circumferential surface of the circumferential wall section 41b, the coolant 42 spread gradually in a direction perpendicular to its flowing direction, so that the portion of the inner circumferential surface of the circumferential wall section 41b that was frontward of the supply port 41c of the cooling drum 41 was entirely covered with the coolant 42.

The rotary blades 5 disposed on the front end face 1a of the multi-nozzle die 1 were rotated at a rotation speed of 2,500 rpm, and the extrudates of the polyethylene terephthalate extrusion-foamed through the outlet ports 11 of the respective nozzles of the multi-nozzle die 1 were cut by the rotary blades 5 to thereby produce substantially spherical particle-shaped cut products. The extrudates of the polyethylene terephthalate had unfoamed portions formed immediately after extrusion from the nozzles of the multi-nozzle die 1 and foamed portions that were continuous with the unfoamed portions and were being foamed. The extrudates of the polyethylene terephthalate were cut at the opening edges of the outlet ports 11 of the nozzles, and the cutting of the extrudates of the polyethylene terephthalate was performed at their unfoamed portions.

To produce the foamed polyethylene terephthalate particles for in-mold foam molding, first, the rotation shaft 2 was not attached to the multi-nozzle die 1, and the cooling component 4 was evacuated from the multi-nozzle die 1. In this state, extrudates of the polyethylene terephthalate were extrusion-foamed from the extruder to check that the extrudates of the polyethylene terephthalate had unfoamed portions formed immediately after extrusion from the nozzles of the multi-nozzle die 1 and foamed portions that were continuous with the unfoamed portions and were being foamed. Then the rotation shaft 2 was attached to the multi-nozzle die 1, and the cooling component 4 was disposed in a prescribed position. Then the rotation shaft 2 was rotated to cut the extrudates of the polyethylene terephthalate by the rotary blades 5 at the opening edges of the outlet ports 11 of the nozzles, whereby particle-shaped cut products were produced.

The cutting stress by the rotary blades 5 caused the particle-shaped cut products to fly outward or forward. Then the particle-shaped cut products collided with the cooling water 42 flowing along the inner surface of the cooling drum 41 of the cooling component 4 in a direction oblique to the surface of the cooling water 42 so as to follow the cooling water 42 from the upstream side of the flow of the cooling water 42 toward the downstream side. The particle-shaped cut products then entered the cooling water 42 and were cooled immediately, whereby foamed polyethylene terephthalate particles for in-mold foam molding were produced.

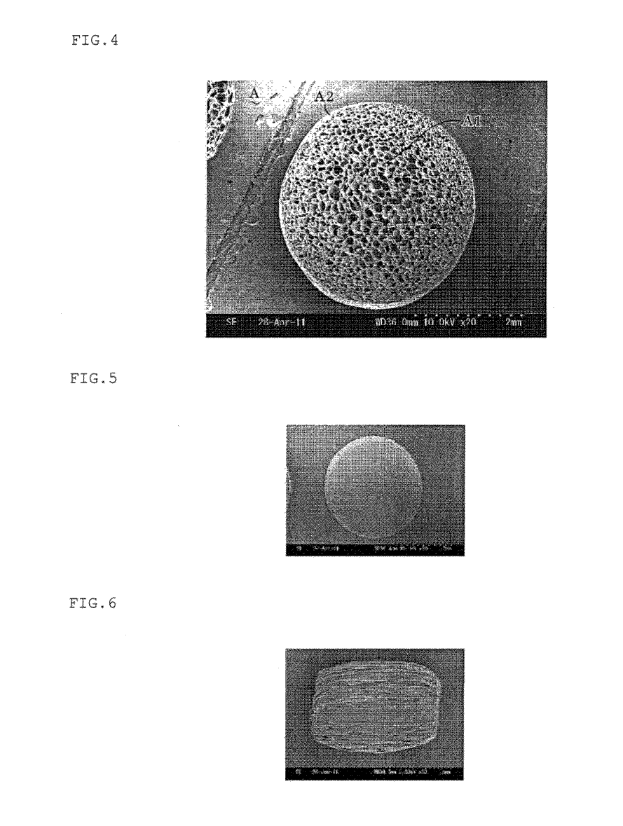

The obtained foamed polyethylene terephthalate particles were discharged together with the cooling water 42 through the discharge port 41e of the cooling drum 41 and then separated from the cooling water 42 by a dewaterer. A photograph of a cross section of a foamed polyethylene terephthalate particle for in-mold foam molding is shown in FIG. 4, the cross section being observed under a scanning electron microscope (SEM) at 20 times. A photograph of the surface of a foamed polyethylene terephthalate particle for in-mold foam molding is shown in FIG. 5, the surface being observed under a scanning electron microscope (SEM) at 20 times.

### Example 2

Foamed polyethylene terephthalate particles for in-mold foam molding were obtained in the same manner as in Example 1 except that butane including 35% by weight of isobutane and 65% by weight of n-butane was injected, in an amount of 0.3 parts by weight based on 100 parts by weight of polyethylene terephthalate, from the mid section of the extruder into the molten polyethylene terephthalate composition and was uniformly dispersed in the polyethylene terephthalate.

### Example 3

Foamed polyethylene terephthalate particles for in-mold foam molding were obtained in the same manner as in Example 1 except that butane including 35% by weight of isobutane and 65% by weight of n-butane was injected, in an amount of 0.65 parts by weight based on 100 parts by weight of polyethylene terephthalate, from the mid section of the extruder into the molten polyethylene terephthalate composition and was uniformly dispersed in the polyethylene terephthalate.

### Example 4

Foamed polyethylene terephthalate particles for in-mold foam molding were produced in the same manner as in Example 1 except that the pyromellitic dianhydride was used in an amount of 0.16 parts by weight instead of 0.2 parts by weight and that butane including 35% by weight of isobutane and 65% by weight of n-butane was injected, in an amount of 0.68 parts by weight based on 100 parts by weight of polyethylene terephthalate, from the mid section of the extruder into the molten polyethylene terephthalate composition and was uniformly dispersed in the polyethylene terephthalate.

### Example 5

Foamed polyethylene terephthalate particles for in-mold foam molding were produced in the same manner as in Example 1 except that the pyromellitic dianhydride was used in an amount of 0.28 parts by weight instead of 0.2 parts by weight and that butane including 35% by weight of isobutane and 65% by weight of n-butane was injected, in an amount of 0.72 parts by weight based on 100 parts by weight of polyethylene terephthalate, from the mid section of the extruder into the molten polyethylene terephthalate composition and was uniformly dispersed in the polyethylene terephthalate.

### Example 6

Foamed polyethylene terephthalate particles for in-mold foam molding were produced in the same manner as in Example 1 except that a polyethylene terephthalate composition was used which contained 100 parts by weight of polyethylene terephthalate (manufactured by Far Eastern Textile Ltd., product name “CH-611,” melting point: 248.9° C., intrinsic viscosity: 1.04), 1.8 parts by weight of a master batch prepared by adding talc to polyethylene terephthalate (content of polyethylene terephthalate: 60% by weight, content of talc: 40% by weight, the intrinsic viscosity of polyethylene terephthalate: 1.04), and 0.14 parts by weight of pyromellitic dianhydride, and that butane including 35% by weight of isobutane and 65% by weight of n-butane was injected, in an amount of 0.65 parts by weight based on 100 parts by weight of polyethylene terephthalate, from the mid section of the extruder into the molten polyethylene terephthalate composition and was uniformly dispersed in the polyethylene terephthalate.

### Example 7

Foamed polyethylene terephthalate particles for in-mold foam molding were produced in the same manner as in Example 1 except that a polyethylene terephthalate composition was used which contained 100 parts by weight of polyethylene terephthalate (manufactured by Far Eastern Textile Ltd., product name “CH-611,” melting point: 248.9° C., intrinsic viscosity: 1.04), 1.8 parts by weight of a master batch prepared by adding talc to polyethylene terephthalate (content of polyethylene terephthalate: 60% by weight, content of talc: 40% by weight, the intrinsic viscosity of polyethylene terephthalate: 1.04), and 0.14 parts by weight of pyromellitic dianhydride, and that butane including 35% by weight of isobutane and 65% by weight of n-butane was injected, in an amount of 0.50 parts by weight based on 100 parts by weight of polyethylene terephthalate, from the mid section of the extruder into the molten polyethylene terephthalate composition and was uniformly dispersed in the polyethylene terephthalate.

### Example 8

Foamed polyethylene terephthalate particles for in-mold foam molding were produced in the same manner as in Example 1 except that a polyethylene terephthalate composition was used which contained 100 parts by weight of polyethylene terephthalate (manufactured by Far Eastern Textile Ltd., product name “CH-611,” melting point: 248.9° C., intrinsic viscosity: 1.04), 1.8 parts by weight of a master batch prepared by adding talc to polyethylene terephthalate (content of polyethylene terephthalate: 60% by weight, content of talc: 40% by weight, the intrinsic viscosity of polyethylene terephthalate: 1.04), and 0.14 parts by weight of pyromellitic dianhydride, and that butane including 35% by weight of isobutane and 65% by weight of n-butane was injected, in an amount of 0.35 parts by weight based on 100 parts by weight of polyethylene terephthalate, from the mid section of the extruder into the molten polyethylene terephthalate composition and was uniformly dispersed in the polyethylene terephthalate.

### Comparative Example 1

First, a polyethylene terephthalate composition containing 100 parts by weight of polyethylene terephthalate (manufactured by Mitsui Chemicals, Inc., product name “SA-135,” melting point: 247.1° C.), 1.8 parts by weight of a master batch prepared by adding talc to polyethylene terephthalate (content of polyethylene terephthalate: 60% by weight, content of talc: 40% by weight, the intrinsic viscosity of polyethylene terephthalate: 0.88), and 0.2 parts by weight of pyromellitic dianhydride was supplied to a single screw extruder having an opening diameter of 65 mm and an L/D ratio of 35 and melted and kneaded at 290° C.

Next, butane including 35% by weight of isobutane and 65% by weight of n-butane was injected, in an amount of 0.7 parts by weight based on 100 parts by weight of polyethylene terephthalate, from a mid section of the extruder into the molten polyethylene terephthalate composition and was uniformly dispersed in the polyethylene terephthalate.

Then the molten polyethylene terephthalate composition was cooled to 280° C. at the front end portion of the extruder, and the cooled polyethylene terephthalate composition was extrusion-foamed into a strand form through the respective nozzles of the multi-nozzle die attached to the front end of the extruder. The multi-nozzle die 1 had 15 nozzles each having an outlet port 11 with a diameter of 0.8 mm.

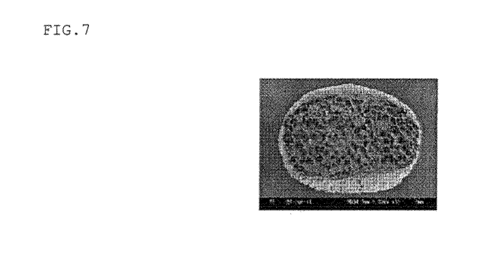

The extrudates of the polyethylene terephthalate in a strand form obtained by extrusion foaming were immediately immersed in water at 20° C. and cooled for 30 seconds. Then the extrudates of the polyethylene terephthalate in a strand form were cut at 2.5 mm intervals to obtain cylindrical foamed polyethylene terephthalate particles for in-mold foam molding. An enlarged photograph of an obtained foamed polyethylene terephthalate particle for in-mold foam molding at 30 times is shown in FIG. 6, and an enlarged photograph at 35 times is shown in FIG. 7. FIG. 6 is a front view, and FIG. 7 is a side view. As can be seem from the enlarged photographs in FIGS. 6 and 7, in the obtained foamed polyethylene terephthalate particle for in-mold foam molding, a plurality of cross sections of cells appeared on the skin layer as viewed from the front, and cross sections of cells also appeared in the side view.

For the above-obtained foamed polyethylene terephthalate particles for in-mold foam molding, their surface coverage, bulk density, degree of crystallinity, open cell ratio, sphericity, and residual carbon dioxide content (after 7 hours) were measured in the manners described above, and the results are shown in TABLE 1.

The Z average molecular weight of the reformed polyethylene terephthalate constituting the obtained foamed polyethylene terephthalate particles for in-mold foam molding was measured in the manner described above, and the results are shown in TABLE 1.

The residual carbon dioxide content (after 1 hour) in the obtained foamed polyethylene terephthalate particles for in-mold foam molding was measured in the following manner, and the results are shown in TABLE 1.

[Residual Carbon Dioxide Content (after 1 Hour)]

The weight W₆ of foamed aromatic polyester-based resin particles for in-mold foam molding was measured. Then the foamed aromatic polyester-based resin particles for in-mold foam molding were supplied to an autoclave to impregnate the foamed aromatic polyester-based resin particles for in-mold foam molding with carbon dioxide under the conditions of 25° C. and 1 MPa for 24 hours.

The foamed aromatic polyester-based resin particles for in-mold foam molding impregnated with carbon dioxide (hereinafter referred to as “carbon dioxide-impregnated foamed particles”) were removed from the autoclave, and the weight W₇ of the carbon dioxide-impregnated foamed particles was measured within 30 seconds after removal.

Then the carbon dioxide-impregnated foamed particles were left to stand at 25° C. and atmospheric pressure for 1 hour, and the weight W₈ of the carbon dioxide-impregnated foamed particles after a lapse of 1 hour was measured.

The residual carbon dioxide content (after 1 hour) in the foamed aromatic polyester-based resin particles for in-mold foam molding was computed using the following formulas.

The amount of impregnation with carbon dioxide immediately after impregnation W₉=W₇−W₆

The amount of impregnation with carbon dioxide after a lapse of 1 hour W₁₀=W₈−W₆

Residual carbon dioxide content (after 1 hour)=100×W₁₀/W₉

TABLE 1

| | | | AMOUNT OF | | | | |
|---|---|---|---|---|---|---|---|
| | AROMATIC POLYESTER- | | CROSS-LINKING | AMOUNT OF | FOAMED PARTICLES | | |
| | BASED RESIN | | AGENT | FOAMING AGENT | BULK | Z AVERAGE | |
| | | INTRINSIC | [PARTS BY | [PARTS BY | DENSITY | MOLECULAR | |
| | TYPE | VISCOSITY | WEIGHT] | WEIGHT] | [g/cm³] | WEIGHT | |
| EXAMPLE 1 | SA135 | 0.88 | 0.20 | 0.70 | 0.14 | 270000 | |
| EXAMPLE 2 | SA135 | 0.88 | 0.20 | 0.30 | 0.41 | 270000 | |
| EXAMPLE 3 | SA135 | 0.88 | 0.20 | 0.65 | 0.16 | 270000 | |
| EXAMPLE 4 | SA135 | 0.88 | 0.16 | 0.68 | 0.14 | 210000 | |
| EXAMPLE 5 | SA135 | 0.88 | 0.28 | 0.72 | 0.14 | 390000 | |
| EXAMPLE 6 | CH611 | 1.04 | 0.14 | 0.65 | 0.17 | 250000 | |
| EXAMPLE 7 | CH611 | 1.04 | 0.14 | 0.50 | 0.23 | 250000 | |
| EXAMPLE 8 | CH611 | 1.04 | 0.14 | 0.35 | 0.34 | 250000 | |
| COMPARATIVE | SA135 | 0.88 | 0.20 | 0.70 | 0.14 | 270000 | |
| EXAMPLE 1 | | | | | | | |
| | | | | | | RESIDUAL CARBON | |
| | | FOAMED PARTICLES | | | | DIOXIDE CONTENT | |
| | | SURFACE | OPEN CELL | | DEGREE OF | [% BY WEIGHT] | |
| | | COVERAGE | RATIO | | CRYSTALLINITY | AFTER | AFTER |
| | | [%] | [%] | SPHERICITY | [%] | 1 HOUR | 7 HOURS |
| | EXAMPLE 1 | 100 | 4.6 | 0.90 | 5.6 | 64.6 | 20.0 |
| | EXAMPLE 2 | 100 | 0.5 | 0.95 | 5.4 | 88.3 | 61.2 |
| | EXAMPLE 3 | 100 | 5.9 | 0.93 | 5.3 | 71.1 | 26.7 |
| | EXAMPLE 4 | 100 | 8.2 | 0.94 | 5.1 | 54.0 | 10.4 |
| | EXAMPLE 5 | 100 | 6.0 | 0.91 | 5.5 | 78.0 | 48.3 |
| | EXAMPLE 6 | 100 | 4.8 | 0.80 | 5.7 | 68.3 | 24.8 |
| | EXAMPLE 7 | 100 | 0.5 | 0.85 | 6.6 | 78.6 | 44.7 |
| | EXAMPLE 8 | 100 | 0.3 | 0.88 | 7.6 | 82.5 | 52.8 |
| | COMPARATIVE | 69 | 20.6 | 0.73 | 5.8 | 53.9 | 1.7 |
| | EXAMPLE 1 | | | | | | |

### Example 9

The foamed polyethylene terephthalate particles for in-mold foam molding obtained in Example 1 were left to stand at 25° C. and atmospheric pressure for 24 hours immediately after production, and then in-mold foam molding was performed in a manner described later to obtain an in-mold foam molded product.

### Example 10

The foamed polyethylene terephthalate particles for in-mold foam molding obtained in Example 2 were left to stand at 25° C. and atmospheric pressure for 24 hours immediately after production, and then in-mold foam molding was performed in the manner described later to obtain an in-mold foam molded product.

### Example 11

The foamed polyethylene terephthalate particles for in-mold foam molding obtained in Example 3 were left to stand at 25° C. and atmospheric pressure for 24 hours immediately after production, and then in-mold foam molding was performed in the manner described later to obtain an in-mold foam molded product.

### Example 12

The foamed polyethylene terephthalate particles for in-mold foam molding obtained in Example 1 were left to stand at 25° C. and atmospheric pressure for 24 hours immediately after production. Then the foamed polyethylene terephthalate particles for in-mold foam molding were placed in a sealed container filled with carbon dioxide, and carbon dioxide was further injected into the sealed container at a pressure of 1.0 MPa. The foamed polyethylene terephthalate particles were left to stand at 20° C. for 24 hours to impregnate the foamed polyethylene terephthalate particles for in-mold foam molding with carbon dioxide. The foamed polyethylene terephthalate particles for in-mold foam molding impregnated with carbon dioxide were removed from the sealed container and left to stand at 25° C. and atmospheric pressure for 7 hours, and then in-mold foam molding was performed in the manner described later to obtain an in-mold foam molded product.

### Example 13

The foamed polyethylene terephthalate particles for in-mold foam molding obtained in Example 4 were left to stand at 25° C. and atmospheric pressure for 24 hours immediately after production, and then in-mold foam molding was performed in the manner described later to obtain an in-mold foam molded product.

### Example 14

The foamed polyethylene terephthalate particles for in-mold foam molding obtained in Example 5 were left to stand at 25° C. and atmospheric pressure for 24 hours immediately after production, and then in-mold foam molding was performed in the manner described later to obtain an in-mold foam molded product.

### Example 15

The foamed polyethylene terephthalate particles for in-mold foam molding obtained in Example 4 were left to stand at 25° C. and atmospheric pressure for 24 hours immediately after production. Then the foamed polyethylene terephthalate particles for in-mold foam molding were placed in a sealed container filled with carbon dioxide, and carbon dioxide was further injected into the sealed container at a pressure of 1.0 MPa. The foamed polyethylene terephthalate particles were left to stand at 20° C. for 24 hours to impregnate the foamed polyethylene terephthalate particles for in-mold foam molding with carbon dioxide. The foamed polyethylene terephthalate particles for in-mold foam molding impregnated with carbon dioxide were removed from the sealed container and left to stand at 25° C. and atmospheric pressure for 7 hours, and then in-mold foam molding was performed in the manner described later to obtain an in-mold foam molded product.

### Example 16

The foamed polyethylene terephthalate particles for in-mold foam molding obtained in Example 5 were left to stand at 25° C. and atmospheric pressure for 24 hours immediately after production. Then the foamed polyethylene terephthalate particles for in-mold foam molding were placed in a sealed container filled with carbon dioxide, and carbon dioxide was further injected into the sealed container at a pressure of 1.0 MPa. The foamed polyethylene terephthalate particles were left to stand at 20° C. for 24 hours to impregnate the foamed polyethylene terephthalate particles for in-mold foam molding with carbon dioxide. The foamed polyethylene terephthalate particles for in-mold foam molding impregnated with carbon dioxide were removed from the sealed container and left to stand at 25° C. and atmospheric pressure for 7 hours, and then in-mold foam molding was performed in the manner described later to obtain an in-mold foam molded product.

### Example 17

The foamed polyethylene terephthalate particles for in-mold foam molding obtained in Example 6 were left to stand at 25° C. and atmospheric pressure for 24 hours immediately after production, and then in-mold foam molding was performed in the manner described later to obtain an in-mold foam molded product.

### Example 18

The foamed polyethylene terephthalate particles for in-mold foam molding obtained in Example 7 were left to stand at 25° C. and atmospheric pressure for 24 hours immediately after production, and then in-mold foam molding was performed in the manner described later to obtain an in-mold foam molded product.

### Example 19

The foamed polyethylene terephthalate particles for in-mold foam molding obtained in Example 8 were left to stand at 25° C. and atmospheric pressure for 24 hours immediately after production, and then in-mold foam molding was performed in the manner described later to obtain an in-mold foam molded product.

### Example 20

The foamed polyethylene terephthalate particles for in-mold foam molding obtained in Example 6 were left to stand at 25° C. and atmospheric pressure for 24 hours immediately after production. Then the foamed polyethylene terephthalate particles for in-mold foam molding were placed in a sealed container filled with carbon dioxide, and carbon dioxide was further injected into the sealed container at a pressure of 1.0 MPa. The foamed polyethylene terephthalate particles were left to stand at 20° C. for 24 hours to impregnate the foamed polyethylene terephthalate particles for in-mold foam molding with carbon dioxide. The foamed polyethylene terephthalate particles for in-mold foam molding impregnated with carbon dioxide were removed from the sealed container and left to stand at 25° C. and atmospheric pressure for 7 hours, and then in-mold foam molding was performed in the manner described later to obtain an in-mold foam molded product.

### Comparative Example 2

The foamed polyethylene terephthalate particles for in-mold foam molding obtained in Comparative Example 1 were left to stand at 25° C. and atmospheric pressure for 24 hours immediately after production, and then in-mold foam molding was performed in the manner described later to obtain an in-mold foam molded product.

### Comparative Example 3

The foamed polyethylene terephthalate particles for in-mold foam molding obtained in Comparative Example 1 were left to stand at 25° C. and atmospheric pressure for 24 hours immediately after production. Then the foamed polyethylene terephthalate particles for in-mold foam molding were placed in a sealed container filled with carbon dioxide, and carbon dioxide was further injected into the sealed container at a pressure of 1.0 MPa. The foamed polyethylene terephthalate particles were left to stand at 20° C. for 24 hours to impregnate the foamed polyethylene terephthalate particles for in-mold foam molding with carbon dioxide. The foamed polyethylene terephthalate particles for in-mold foam molding impregnated with carbon dioxide were removed from the sealed container and left to stand at 25° C. and atmospheric pressure for 7 hours, and then in-mold foam molding was performed in the manner described later to obtain an in-mold foam molded product.

### [In-Mold Foam Molding]

Foamed polyethylene terephthalate particles for in-mold foam molding were filled into a cavity of an aluminum-made mold. The inside dimensions of the cavity of the mold were length 30 mm×width 300 mm×height 300 mm, and the cavity had a cuboidal shape. To allow the cavity of the mold to be in communication with the outside of the mold, 252 circular supply ports with a diameter of 8 mm were formed in the mold at 20 mm intervals. A grid portion with an opening width of 1 mm was provided in each of the supply ports so that the foamed polyethylene terephthalate particles for in-mold foam molding filled into the mold were prevented from flowing out of the mold through the supply ports. In this configuration, water vapor was allowed to be smoothly supplied to the cavity from the outside of the mold through the supply ports of the mold.

Then water vapor at 105° C. was supplied to the cavity to heat and foam the foamed polyethylene terephthalate particles for in-mold foam molding, whereby the foamed particles were heat-fused and integrated with each other.

Then cooling water was supplied to the cavity to cool the in-mold foam molded product in the mold, and the cavity was opened to remove the in-mold foam molded product.

The density, maximum point load, maximum point stress, maximum point displacement, fusion bonding ratio, and appearance of each of the obtained in-mold foam molded products were measured in the following manners, and the results are shown in TABLE 2.

### [Bulk Density]

The weight W₁₁ of an in-mold foam molded product was measured, and the apparent volume V of the in-mold foam molded product was measured. The weight W₁₁ was divided by the volume V to compute the density of the in-mold foam molded product.

### [Maximum Point Load (Bending Strength)]

Five cuboidal test pieces of length 20 mm×width 25 mm×height 130 mm were cut from an in-mold foam molded product, and a bending test was performed on each test piece according to JIS 7221-1 to measure the maximum point load of the test piece. The arithmetic mean of the maximum point load values of these test pieces was used as the maximum point load of the in-mold foam molded product. A TENSILON universal testing machine commercially available under the product name “UCT-10T” from ORIENTEC Co., Ltd. was used as the measuring apparatus.

### [Maximum Point Stress (Bending Strength)]

Five cuboidal test pieces of length 20 mm×width 25 mm×height 130 mm were cut from an in-mold foam molded product, and a bending test was performed on each test piece according to JIS 7221-1 to measure the maximum point stress of the test piece. The arithmetic mean of the maximum point stress values of these test pieces was used as the maximum point stress of the in-mold foam molded product. The TENSILON universal testing machine commercially available under the product name “UCT-10T” from ORIENTEC Co., Ltd. was used as the measuring apparatus.

### [Maximum Point Displacement (Bending Strength)]

Five cuboidal test pieces of length 20 mm×width 25 mm×height 130 mm were cut from the in-mold foam molded product, and a bending test was performed on each test piece according to JIS 7221-1 to measure the maximum point displacement of the test piece. The arithmetic mean of the maximum point displacement values of these test pieces was used as the maximum point displacement of the in-mold foam molded product. The TENSILON universal testing machine commercially available under the product name “UCT-10T” from ORIENTEC Co., Ltd. was used as the measuring apparatus.

### [Fusion Bonding Ratio]

An in-mold foam molded product was bent and cut at a prescribed portion. The total number N₁ of foamed particles appearing on the cut surface of the in-mold foam molded product was counted visually, and the number N₂ of foamed particles that had undergone material fracture, i.e., the number of divided foamed particles, was counted visually. The fusion bonding ratio can be computed using the following formula.

Fusion bonding ratio (%)=100×the number N₂ of foamed particles that had undergone material fracture/the total number N₁ of foamed particles

### [Appearance]

The appearance of each of the obtained in-mold foam molded products was evaluated according to the following criteria.

Good: No cross sections of cells appeared on the surface of the in-mold foam molded product, and the in-mold foam molded product had good looking appearance.

Bad: Cross sections of cells appeared on the surface of the in-mold foam molded product, and the skin portions and the cross sections of cells formed a mottled texture.

TABLE 2

| | | MAXIMUM | MAXIMUM | MAXIMUM | FUSION | |
|---|---|---|---|---|---|---|
| | BULK | POINT | POINT | POINT | BONDING | |
| | DENSITY | LOAD | STRESS | DISPLACEMENT | RATIO | |
| | [g/cm³] | [N] | [MPa] | [mm] | [%] | APPEARANCE |
| EXAMPLE 9 | 0.14 | 82 | 1.16 | 3.3 | 70 | GOOD |
| EXAMPLE 10 | 0.41 | 140 | 1.99 | 1.1 | 40 | GOOD |
| EXAMPLE 11 | 0.16 | 100 | 1.28 | 2.6 | 65 | GOOD |
| EXAMPLE 12 | 0.14 | 89 | 1.19 | 4.1 | 80 | GOOD |
| EXAMPLE 13 | 0.14 | 78 | 1.10 | 3.5 | 75 | GOOD |
| EXAMPLE 14 | 0.14 | 83 | 1.15 | 3.1 | 55 | GOOD |
| EXAMPLE 15 | 0.14 | 85 | 1.14 | 4.3 | 80 | GOOD |
| EXAMPLE 16 | 0.14 | 88 | 1.18 | 3.5 | 65 | GOOD |
| EXAMPLE 17 | 0.17 | 83 | 1.15 | 3.2 | 55 | GOOD |
| EXAMPLE 18 | 0.23 | 127 | 1.82 | 2.5 | 50 | GOOD |
| EXAMPLE 19 | 0.34 | 158 | 2.24 | 1.5 | 35 | GOOD |
| EXAMPLE 20 | 0.17 | 91 | 1.20 | 4.3 | 65 | GOOD |
| COMPARATIVE | 0.14 | 59 | 0.81 | 3.8 | 30 | BAD |
| EXAMPLE 2 | | | | | | |
| COMPARATIVE | 0.14 | 61 | 0.81 | 4.5 | 30 | BAD |
| EXAMPLE 3 | | | | | | |

### INDUSTRIAL APPLICABILITY

The foamed aromatic polyester-based resin particles for in-mold foam molding according to the present invention have a long shelf life after production and high heat-fusion bondability. The in-mold foam molded product molded using the foamed aromatic polyester-based resin particles of the present invention has high mechanical strength and good appearance and can be preferably used for transportation packaging component and automobile component applications.

### REFERENCE SIGNS LIST

1 Nozzle die
2 Rotary shaft
3 Driving component
4 Cooing component
41 Cooling drum
42 Coolant
5 Rotary blade
P Foamed aromatic polyester-based resin particles for in-mold foam molding

1. A foamed aromatic polyester-based resin particles for in-mold foam molding, comprising an aromatic polyester-based resin, wherein a content of residual carbon dioxide 7 hours after the particles are impregnated with carbon dioxide for 24 hours under conditions of 25° C. and 1 MPa is 5% by weight or more.

2. The foamed aromatic polyester-based resin particles for in-mold foam molding according to claim 1, wherein a Z average molecular weight of the aromatic polyester-based resin constituting the foamed aromatic polyester-based resin particles for in-mold foam molding is 2.0×10⁵ or higher.

3. The foamed aromatic polyester-based resin particles for in-mold foam molding according to claim 1, wherein an open cell ratio thereof is less than 15%.

4. The foamed aromatic polyester-based resin particles for in-mold foam molding according to claim 1, wherein each foamed aromatic polyester-based resin particle includes a foamed aromatic polyester-based resin particle main body and an unfoamed skin layer that covers a surface of the foamed aromatic polyester-based resin particle main body, and a surface coverage of the foamed aromatic polyester-based resin particle with the skin layer is 80% or higher.

5. The foamed aromatic polyester-based resin particles for in-mold foam molding according to claim 1, wherein a sphericity thereof is 0.7 or more.

6. The foamed aromatic polyester-based resin particles for in-mold foam molding according to claim 1, wherein a degree of crystallinity thereof is less than 15%.

7. The foamed aromatic polyester-based resin particles for in-mold foam molding according to claim 1, wherein a bulk density thereof is 0.05 to 0.7 g/cm³.

8. A method of producing foamed aromatic polyester-based resin particles for in-mold foam molding, the method comprising the steps of: supplying an aromatic polyester-based resin to an extruder to melt and knead the aromatic polyester-based resin in the presence of a foaming agent; while an extrudate of the aromatic polyester-based resin extruded from a nozzle die attached to a front end of the extruder is extrusion-foamed, cutting the extrudate of the aromatic polyester-based resin to produce particle-shaped cut products; and cooling the particle-shaped cut products.

9. The method of producing foamed aromatic polyester-based resin particles for in-mold foam molding according to claim 8, wherein 100 parts by weight of the aromatic polyester-based resin having an intrinsic viscosity of 0.8 to 1.1 and 0.01 to 5 parts by weight of a cross-linking agent are supplied to the extruder to cross-link the aromatic polyester-based resin with the cross-linking agent.

10. An in-mold foam molded product obtained by using, the foamed aromatic polyester-based resin particles for in-mold foam molding according to claim 1 and performing in-mold foam molding.

11. A composite structural component comprising the in-mold foam molded product according to claim 10; and a skin material stacked on and integrated with a surface of the in-mold foam molded product.

12. A component for an automobile, comprising the in-mold foam molded product according to claim 10.

13. A component for an automobile, comprising the composite structural component according to claim 11.
